(19) United States
(12) Patent Application Publication
(10) Pub. No.: US 2010/0181154 A1
(43) Pub. Date: Jul. 22, 2010

(54) ADVANCED TRIPLE PISTON DAMPER

(75) Inventor: Pinyo PANICHGASEM, Bangkok (TH)

Correspondence Address: Pearne & Gordon LLP, 1801 East 9th Street, Suite 1200, Cleveland, OH, 44114-3108, US

(73) Assignee: Y.S.S. (THAILAND) CO., LTD., Samutprakarn (TH)

(21) Appl. No.: 12/533,663

(22) Filed: Jul. 31, 2009

(30) Foreign Application Priority Data
Jan. 19, 2009 (TH) 0901000202

(51) Int. Cl. F16F 9/508

(52) U.S. Cl. 188/280

(57) ABSTRACT

An advanced triple piston damper (ATPD), comprises of three pistons (1), (2) and (3) working in relation, characterizes that the piston set is designed to work as a damper for a pull-type shock absorber having three pistons performable at slow, intermediate, and high stroking speed. The respond of the shock absorber of the present invention is, therefore, much better than any gas type shock absorber of the prior art. In addition, the leakage problem is also avoided.

### FIELD OF THE INVENTION

Mechanical engineering, motorcycle

### BACKGROUND OF THE INVENTION

The advanced triple piston damper (ATPD) or the advanced triple-piston shock absorber of the present invention relates to the piston set of the pull-type shock absorber of a motorcycle. The piston set of the present invention is designed to perform as a damper for the pull-type shock absorber which has 3 pistons performable at slow, intermediate and high stroking speed.

The objective of the present invention is to provide a 3-piston shock absorber having respond better than any previous designs and nitrogen gas-type shock absorber. In addition, the shock absorber of the present invention also avoids leakage problem from the body of the shock absorber.

Typical shock absorber comprises of one or two pistons. For the mono-piston type shock absorber, the piston will counter the oil pressure when the piston rod moves. For the double-piston type shock absorber, a piston works in the same manner as the piston of the mono-piston type shock absorber while the second piston pressurizes the oil according to the pressure occurring in the cylinder. The movement of the second piston is caused by the pressure from nitrogen gas filled in the cylinder.

From the above mentioned problems, the objective of the present invention is therefore to provide a better piston set for the pull-type shock absorber of a motorcycle.

### BRIEF DESCRIPTION OF THE DRAWINGS

FIG. 1 shows the internal structure of the advanced triple piston damper (ATPD) of the present invention.

### DETAIL DESCRIPTION OF THE PREFERRED EMBODIMENTS

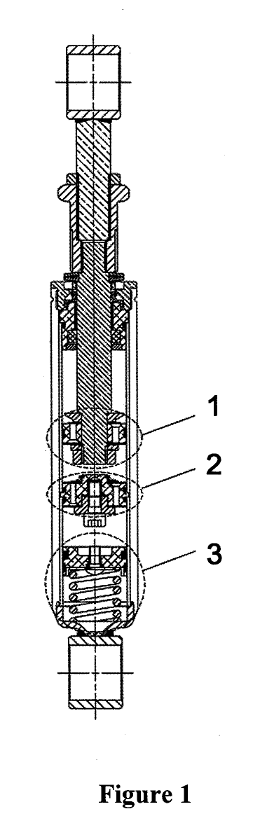

First, let consider FIG. 1 which shows the internal structure of the advanced triple piston damper (ATPD) of the present invention. The ATPD of the present invention comprises of 3 pistons. The first piston (1) counters the oil pressure when the piston moves in and out.

The second piston (2) also counters the oil pressure in the same manner as the first piston without having any displacement. During operation, the second piston (2) counters the oil pressure by using the thickness of the shims provide at both side of the piston.

The third piston (3) counters the oil pressure by using pressure from a spring loaded inside the cylinder rather than the pressure from nitrogen gas. When the piston rod of the third piston (3) moves, the third piston (3) will move while having resistance from the oil pressure acts above the piston and from the force of the spring acts beneath the piston.

Since the shock absorber of the present invention has three pistons work in relation, the respond of the shock absorber of the present invention is, therefore, much better than any gas type shock absorber of the prior art. In addition, the leakage problem is also avoided. An improved pull-type shock absorber for motorcycle is thus achieved. The shock absorber of the present invention also performs very well at low, intermediate, and high stroking speed.

What is claimed is:

1. An advanced triple piston damper (ATPD), comprises of three pistons (1), (2) and (3) working in relation, characterizes that the piston set is designed to work as a damper for a pull-type shock absorber having three pistons performable at slow, intermediate, and high stroking speed.
